(19) United States
(12) Patent Application Publication
(10) Pub. No.: US 2009/0045168 A1
(43) Pub. Date: Feb. 19, 2009

(54) Surface Treater for Elongated Articles

(76) Inventors: Jacob Hanson, West Allis, WI (US); Joseph Roethle, Jackson, WI (US)

Correspondence Address: QUARLES & BRADY LLP, 411 E. WISCONSIN AVENUE, SUITE 2040, MILWAUKEE, WI, 53202-4497, US

(21) Appl. No.: 12/191,826

(22) Filed: Aug. 14, 2008

Related U.S. Application Data
(60) Provisional application No. 60/956,606, filed on Aug. 17, 2007.

(51) Int. Cl. H05H 1/46

(52) U.S. Cl. 216/71; 156/345.38; 156/345.33

(57) ABSTRACT

A surface treater system for three dimensional articles, especially elongated articles such as wires, cables and the like, increases the surface tension of the articles and thereby can be used to clean, etch and improve the wettabliity of the surface for inks, dyes, adhesives and the like. The treated article is supported by one or more guides that guide it through a long, narrow treatment zone. Two or more elongated electrodes are arranged in the treater to ionize working media within the treatment zone. The working media can be diffused and injected evenly along the entire length of the treatment zone to ensure consistent treatment along a long length of the treated article. An elongated barrier member can be provided to contain the working media in the treatment zone. Alternatively, working media can be injected and diffused from multiple, preferably opposing, sides of the treatment zone to further contain and disperse the working media, and provide essentially full-periphery surface treatment.

### CROSS-REFERENCE TO RELATED APPLICATIONS

This application claims benefit to U.S. provisional application Ser. No. 60/956,606, filed Aug. 17, 2007.

### STATEMENT OF FEDERALLY SPONSORED RESEARCH/DEVELOPMENT

Not applicable.

### BACKGROUND OF THE INVENTION

The invention generally relates to systems for charging, and thereby altering certain characteristics of, the surfaces of articles, for example wettability, or the ability of the surface to take on liquids, such as inks, dyes and adhesives that may be applied to the articles for marking or other purposes. In particular, the invention relates to treater stations providing improved surface treatment of elongated articles, such as wires, cables and the like.

It is common for articles to have printing, coating or bonding directly on the surfaces of the articles to serve any number of purposes, including for example, decoration and textual or graphical indicia of a characteristic of the article or its use. For example, it is common for wire and cable to have its outer sheath flagged, coated or printed with striping to indicate wire gauge or intended polarity.

The dielectric material, such as fluoropolymers, polyalkylenes, and the like, used for wire and cable insulation or sheathing typically provides low surface energy, chemically inert surfaces. Furthermore, the extrusion processes in which the insulation or sheathing is formed onto the wire or cable can create localized variations in surface roughness, porosity and crystallinity caused by factors such as variations in baking temperatures, line speed and humidity. Consequently, the surfaces of these articles often have roughness, porosity, and wettability characteristics that are often unsuitable for printing, coating and bonding applications.

The properties of these surfaces can be improved, for example to better apply adhesives and inks, by treating the surface of the material to raise its surface tension. Surface tension can be raised using any of a number of known techniques including IR, UV, x-ray and gamma ray irradiation, electron and ion beam bombardment, ozone exposure and flame, chemical, corona and plasma treatments.

Corona treaters have been used for many years, however, plasma treaters are widely recognized as providing a more uniform and controllable surface treatment than corona treaters. In plasma treaters, the treatment zone is infused with an inert gas that is partially ionized by the energized electrodes. Early plasma treaters required that the pressure of the ionized gas was reduced well below atmospheric pressure. This required expensive and cumbersome vacuum chambers and pumps to maintain the low pressure at the treatment zone. However, more recently treaters forming plasma at atmospheric pressure have been developed, see U.S. Pat. No. 5,456,972. In this process, often termed “glow discharge plasma” treatment, the plasma would form at atmospheric pressure provided an inert gas, typically helium, was used, a dielectric was applied between the electrodes and the operating frequency and voltage of power source was properly selected. The operating frequencies ranged up to as much as 100 kHz, however it was typically operated at much less so as not to avoid the ambient air from being too readily ionized by the high frequency electric field, and thus forming corona treatment rather than the more effective plasma treatment.

Furthermore, these techniques are often used to effect surface treatment in large scale operations as part of an assembly or other process line. The material is ordinarily fed through a treatment zone in which the surface energy of one surface of the material is raised.

Many chemical, corona and plasma treater stations exist for treating the surfaces of papers, laminates and other thin web stock in which the material is supported in the treatment zone by a roller typically serving as a ground electrode. An active electrode is located on the opposite side of the material from the roller to produce an electric field through which the web passes.

However, treater stations of this type are not typically suitable for articles that have a greater three-dimensional profile, such as wire and cables, because the increased spacing between the electrodes required to accommodate the thickness of such articles can diminish or destroy the formation of the corona or plasma, for example, and thus the effectiveness of the treatment.

As a result, such articles have been conventionally treated with systems having discrete discharge heads or cylindrical electrodes. In the former case, one or more discharge heads are arranged to direct a beam or other spray of ionized particles at a discrete location of the wire or cable. In the latter case, the wire or cable is threaded into cylindrical electrode and passed through a curtain of ionized particles. Because the wires and cables are elongated articles which are often treated in long lengths, the use of discrete discharge heads can be disadvantages because of the narrow beams can readily burn or damage the surface or create inconsistencies in treatment should the line speed be varied. The use of cylindrical electrodes requires the articles to be threaded through the treater, thus complicating integration with other components of the line.

### SUMMARY OF THE INVENTION

The present invention provides a treater system that addresses the above-mentioned concerns and facilitates the surface treatment of three-dimensional objects, particularly elongated articles such as wires, cables and the like.

Specifically, in one aspect the invention provides a surface treater system for treating the surface of an elongated article. The treater has a guide for supporting the elongated article along a treatment axis. First and second elongated electrodes, each extending primarily essentially parallel to the treatment axis, are spaced apart to define an elongated treatment zone extending along the treatment axis between the electrodes. An elongated nozzle extends primarily essentially parallel to the treatment axis proximate the first and second electrodes for introducing a working media into the treatment zone and dispersing it along the treatment axis. A power supply operatively connected to the first and second electrodes ionizes the working media in the treatment zone along the treatment axis and thereby increases the tension at the surface of the elongated article.

Another aspect of the invention provides a plasma treater for treating an elongated article. The treater has a cabinet creating a treatment chamber open at opposite ends of the cabinet. A guide is mounted at each open end of the cabinet for guiding the elongated article and establishing a treatment axis therebetween passing through the treatment chamber along which the elongated article is disposed. An electrode assembly is mounted within the treatment chamber. The electrode assembly has an active electrode coupled to high voltage and a ground electrode coupled to ground, each disposed essentially parallel to the treatment axis. The electrodes are spaced apart to define a treatment zone along the treatment axis between the electrodes. An elongated gas nozzle, which extends essentially parallel to the treatment axis adjacent to the active and ground electrodes, is coupled to a gas line for introducing a gas into the treatment zone and dispersing it along the treatment axis. Energization of the power supply causes the gas to ionize and form plasma in the treatment zone along the treatment axis.

Yet another aspect of the present invention provides a process for charging the surface of elongated articles. The process includes supporting an elongated article along a treatment axis so that it extends primarily in the direction of extension of the treatment axis. An electrode assembly is provided which has at least a first electrode coupled to high voltage and a second electrode coupled to ground. The electrode assembly is disposed so that the first and second electrodes extend primarily essentially parallel to the treatment axis and are spaced apart to define an elongated treatment zone along the treatment axis. A working media is provided within the treatment zone, and upon energizing the electrode assembly, the working media within the treatment zone is ionized along the treatment axis, which thereby increasing the surface tension of the elongated article. The elongated article can be supported on movable guides and conveying along the treatment axis through the treatment zone.

The advantages of the invention will be apparent from the detailed description and drawings. What follows are one or more preferred embodiments of the present invention. To assess the full scope of the invention, the claims should be looked to as no one embodiment is intended to fully set forth the scope of the invention.

### BRIEF DESCRIPTION OF THE DRAWINGS

FIG. 1 is a front elevational view of a surface treater system according to the present invention;

FIG. 2 is a side elevational view thereof;

FIG. 3 is a perspective view of an electrode assembly and mounting arrangement for mounting the electrode assembly within the treater of FIG. 1;

FIG. 4 is an exploded view thereof;

FIG. 5 is a partial front sectional view thereof showing the cooling air flow through the electrodes;

FIG. 6 is a partial sectional view taken along line 6-6 of FIG. 3 showing the flow working media into the treatment zone and adjustable mounting of the electrodes; and

FIG. 7 is a partial sectional view of an alternate embodiment of the treater system having two opposing nozzles for injecting working media into the treatment zone.

### DETAILED DESCRIPTION OF THE PREFERRED EMBODIMENT(S)

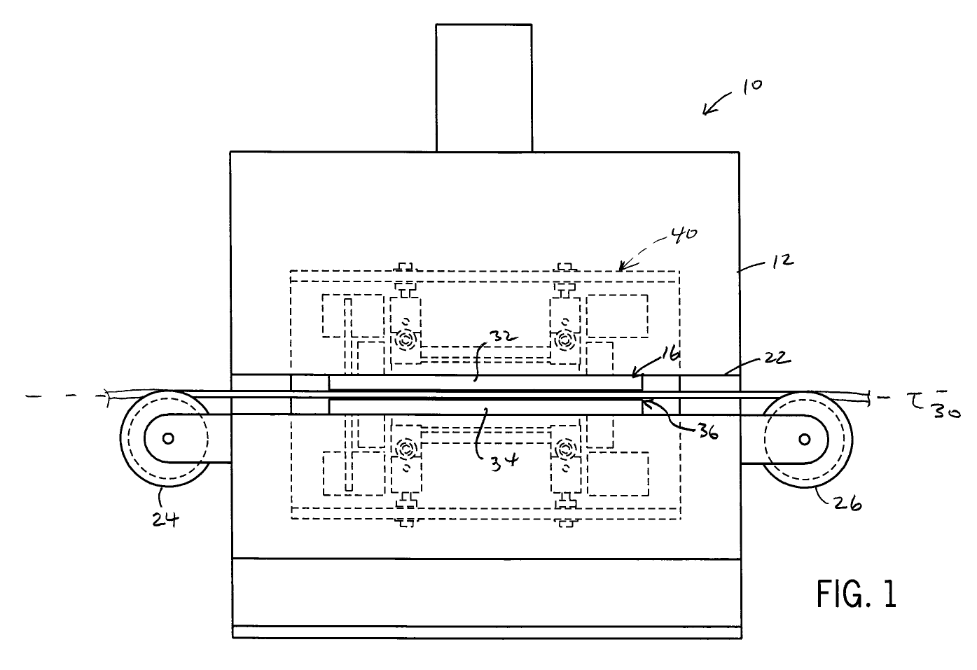

Referring now to the drawings, in particular FIGS. 1-3, which illustrate one embodiment of a surface treater for elongated articles according to the present invention in the form of a plasma treater system 10. The treater system 10 generally includes a cabinet 12 containing a high voltage power transformer 14 (coupled to a remote power supply and any applicable electronics not shown), an electrode assembly 16, which is coupled to the power supply, a working media system 18, and a cooling air system 20. The general operation of the treater system 10 is that an elongated article is fed past the electrode assembly 16, which when energized by the power supply, ionizes the working media to create plasma. The interaction of the plasma with the surface of the elongated article increases the surface tension and thereby improves the functionality of the surface, specifically, making it better able to accept inks, dyes, coatings, adhesives and the like. To reduce the heat of the electrode assembly 16 during operation, cooling air is passed by or through the electrodes.

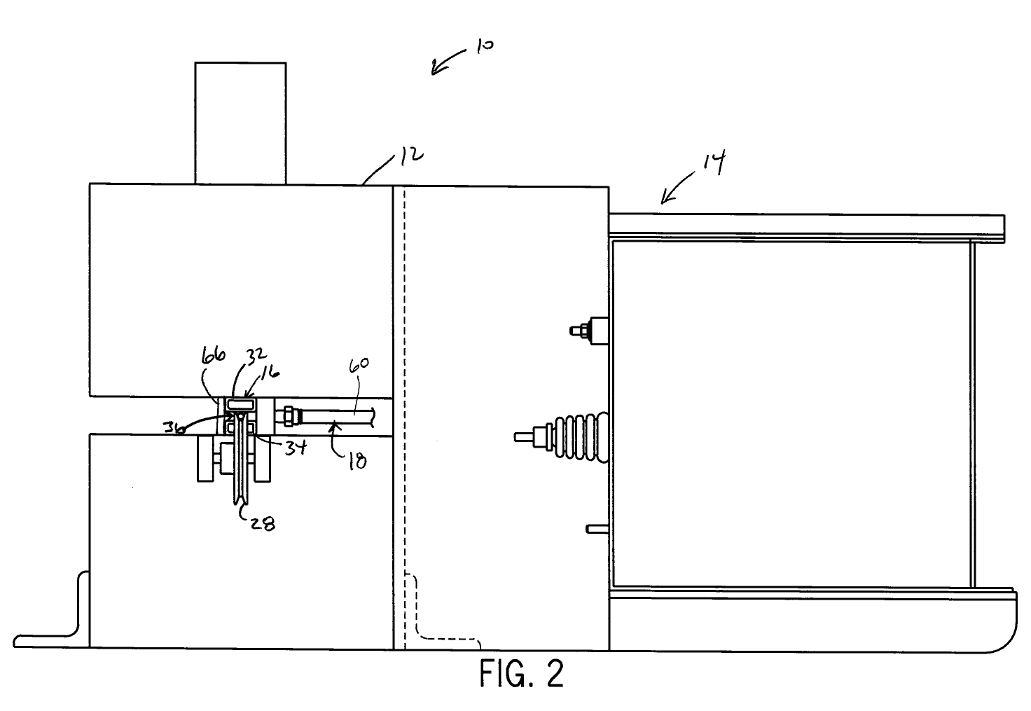

More specifically now, the cabinet 12 defines a work space for treating the elongated articles that is accessible through an opening 22 extending along the front and sides of the cabinet 12, as shown in FIGS. 1 and 2. The opening 22 is tall enough to allow the articles to be fed into the treater 10 easily and without the need for threading, while still providing a somewhat confined space for shrouding and containing the plasma. While the cabinet 12 shown in the drawings is fixed, it could also be hinged in any suitable manner to allow the work space to be accessed more easily. For example, the top hood portion of the cabinet 12, and even one of the electrodes, could be allowed to pivot backward in clamshell fashion. In any event, at the sides of the cabinet 12 are mounted guides 24 and 26 for supporting and positioning the articles for treatment. The guides 24 and 26 could be any type of supporting surface, however, for use in line-feed systems, the guides 24 and 26 should take the form of fixed low-friction glides or rotating wheels or rollers. In the case of wire and cable type articles, the guides 24 and 26 can be rotatably mounted sheaves or pulleys that define a circumferential groove 28 (see FIG. 2) receiving the body of the wire or cable. The guides 24 and 26 are aligned on each side of the cabinet 12 along a treatment axis 30. Preferably, as with the grooves 28 shown, the guides not along support the articles, but with proper tension also fix the position of the articles to be coaxial with the treatment axis 30. This ensures proper spacing of the articles with respect to the electrode assembly 16, and thereby consistent treatment throughout the length of the article.

The exact configuration and electrode count of the electrode assembly 12 can be varied, provided that two different components constitute the positive (or charged) electrode and the ground electrode, or that the electrodes are appropriately phase-shifted so as to effect discharge between them. In some cases in which the article to be treated has a suitable conductive element, that conductive element by constitute an electrode, in particular the ground electrode. However, in typical applications, there will be at least one dedicated active (or positive) electrode and at least one dedicated ground (or negative) electrode. The quantity of electrodes can be selected based on the application, considering factors such as cost, level of refinement needed, size of the articles and line feed rate. Moreover, the placement of the electrodes with respect to the treatment axis 30 can also be varied. For example, with the proper selection and wiring of the electrodes, two or more electrodes could be placed to one side of the treatment axis 30, with none or one or more electrodes opposite polarity on the opposite side of the treatment axis 30. More specifically, successive alternating polarity electrodes could be provided on each side of the treatment axis 30. Or, one or more pairs of opposed polarity electrodes could be positioned on the same side of the treatment axis 30 such that the plasma formed therebetween would interact with the article form one side of the treatment axis 30. Similar polarity electrodes could also be situated on the same side of the treatment axis 30 provided the article itself or a separate electrode at the other side of the treatment axis 30 provided the ground. Or one or more pairs of opposed polarity electrodes could be situated on opposite sides of the treatment axis 30. For example, in the treater 10 shown in the figures, the electrode assembly 16 includes one active electrode 32 and one ground electrode 34 that are spaced apart on opposite sides of, and parallel to, the treatment axis 30 to define a treatment zone 36 therebetween.

As mentioned above, it is possible for two or more electrodes to be charged, that is connected to high voltage, without one or more corresponding ground electrodes, provided the electrodes are phase-shifted. For example, one electrode could be coupled the high voltage transformer at 0 degrees and another at 180 degrees so that the two are 180 degrees out of phase. The two electrodes will have opposite polarity and will effect discharge between them, as would an active and ground electrode pair. Using active (charged) electrodes without corresponding ground electrode(s) is beneficial when treating articles having a grounded conductor. This is because the potential of both (or all) of the electrodes varies from the potential of the treated article, which is at ground potential, and thereby better facilitates discharge between each electrode and the treated article compared to when using ground electrodes that are at the same potential as the treated article. This results in better treatment from each side of the treatment axis having an electrode, and thus can more readily treat the fully periphery of the article.

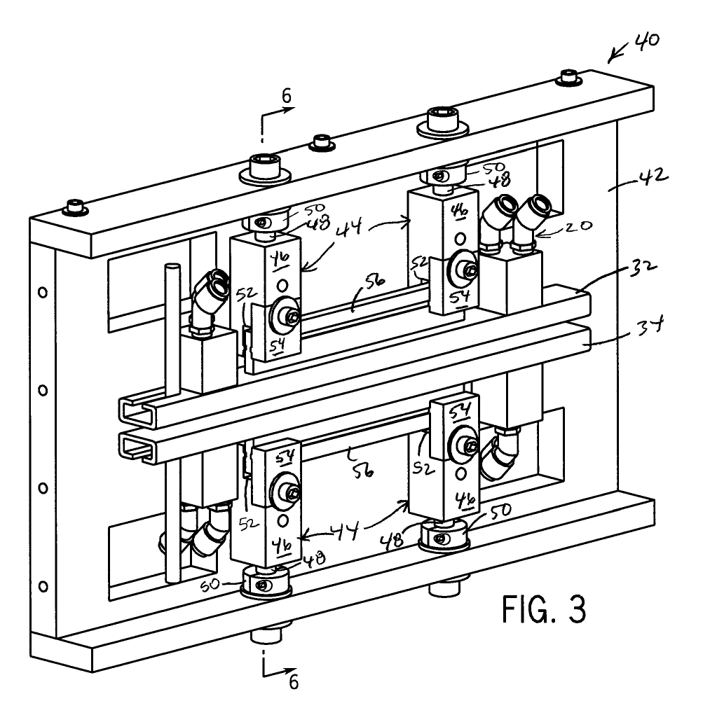

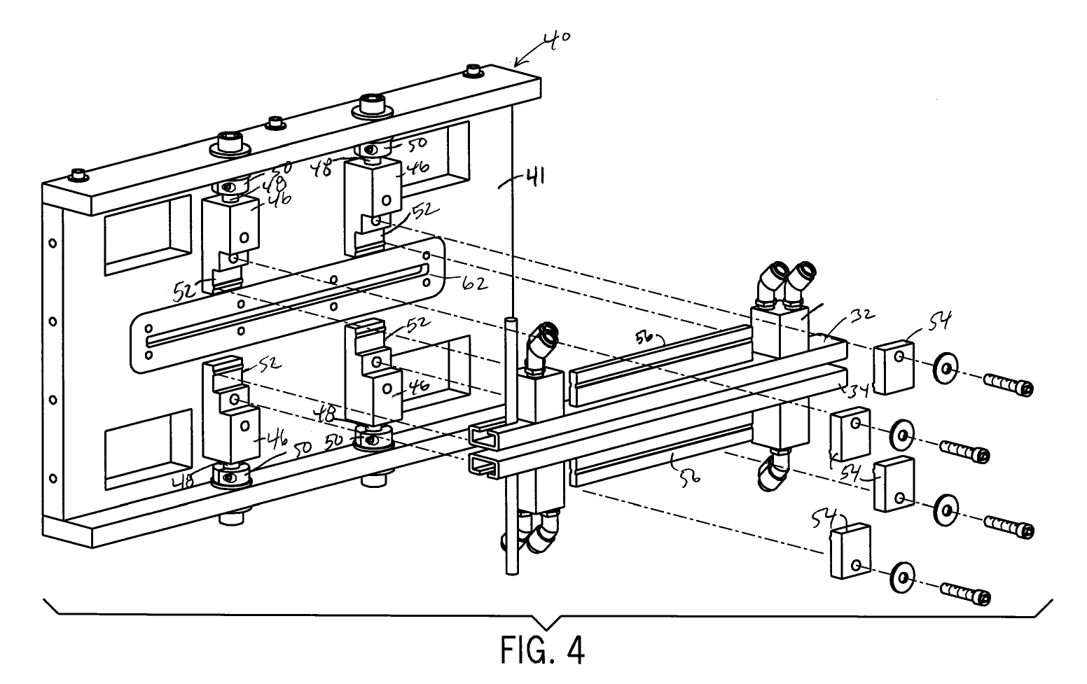

As shown in FIGS. 3-6, both of the electrodes 32 and 34 are elongated tubes that extend across substantially the entire width of the working space of the treater 10, that is essentially in the long dimension of the articles to be treated. The tubular electrodes 32 and 34 have a generally rectangular cross-section defining flat surfaces in the short (transverse or front to back) and long (axial or side to side) dimensions. The electrodes 32 and 34 can be made of any suitable metal or other conductive material. However, in the treater 10 described herein the electrodes 32 and 34 are ceramic with each having a metallic electrode strip (not shown), preferably made of a highly electrically conductive material, such as copper, to provide a flat discharge surface that faces the treatment axis 30. The active electrode 32 is electrically coupled to the high voltage power transformer 14 and the ground electrode 34 is coupled to ground.

The electrodes 32 and 34 a primary dimension of extension that is parallel to the treatment axis 30, and thus, the treatment zone 36 is lengthy and able to treat a sizable length of the articles at once. This speeds the treatment process and also improves the consistency and homogeneity of the treatment since less variations in operational parameters, such as feed rate, charge dispersion, charge intensity, will occur per unit length of the treated article. For this reason, the treatment provided by the present invention is an improvement over that provided by the shorter cylindrical electron treaters and the discrete discharge head treaters. In the treater 10 described herein, each of the electrodes 32 and 34, and thus the treatment zone 36, is 250 mm in length. However, it is contemplated that the electrodes 32 and 34 could range between about 25 and 2,500 mm depending on the application.

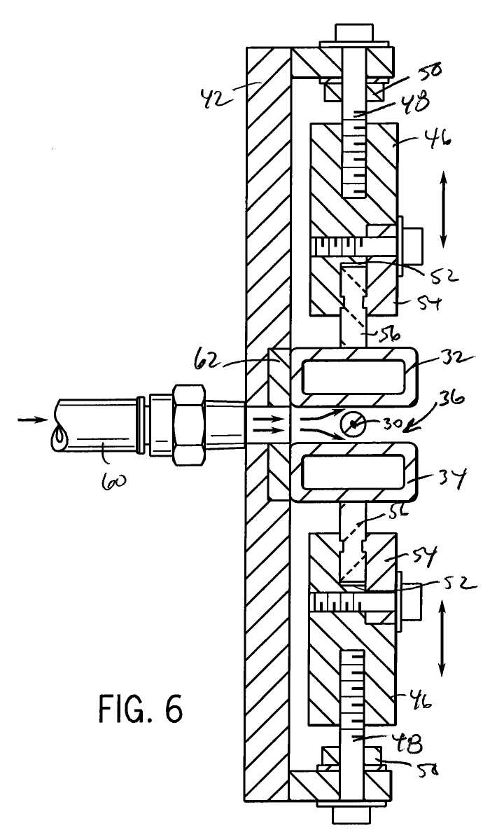

The electrodes 32 and 34 are mounted within the working space of the treater 10 by an electrode mount 40. The electrode mount 40 has a large bracket or plate 42 to which bolt adjustable mounting clamps 44, four in all for the treater 10 described herein. Specifically, each of the clamps 44 has a base 46 that bolts onto the bracket 42 via a bolt 48. Adjustment of the bolt 48 and a locking collar 50 allows for adjustment of the vertical position of the clamp 44. The base 46 has a notch 52 at one end where a clamp piece 54 is bolted to the base 46. The notch 42 receives an end of an electrode mount 56, which is in turn mounted to one of the electrodes 32 and 34. In this way, the electrodes 32 and 34 can be held in a fixed position relative to the treatment axis 30, and also may be readily mounted and dismounted by adjusting the bolts holds the clamp pieces 54 as well as adjusted vertically (as noted by the arrows in FIG. 6) by adjusting bolt 48 and locking collar 50. As such, the height (and thus volume) of the treatment zone 36, particularly the gap height (or width), between the electrodes 32 and 34 can be changed to accommodate articles of different cross-sectional dimensions as well as to set the gap height of the electrodes 32 and 34 so that each are equidistant from the treatment axis 30. The described mounting arrangement provides for independent adjustment of each electrode 32 and 34 with respect to the treatment axis 30, both in the transverse and axial dimensions. If desired, the mounting arrangement could be configured to adjustably maintain an equal distance from the treatment axis for both electrodes. In any event, the bracket 42 and clamp 44 components are preferably made of a heat resistant, non-corrosive and non-conducting material, such as a suitable phenolic. And the electrode mounts 56 have similar characteristics and are preferably a ceramic material jointed to the electrodes 32 and 34 by a suitable adhesive, such as silicon rubber based adhesive. It should be noted also that the electrode mounts 56 could be an integral part of the electrodes 32 and 34, or the electrodes 32 and 34 could be mounted directly to the clamps 44 without separate mounts.

The principles of the present invention can be used to provide corona, chemical corona and/or plasma discharge treatment, using a single gas or a mixture of gases, including air, one or more inert gases (such as nitrogen and helium), or other suitable gas chemistry mixtures, including mixtures of inert and reactive gases (such as oxygen, hydrogen, acetylene, etc.) as the working media. Further, with the present invention the treatment can be achieved at atmospheric pressure, thereby avoiding the need to pressurize or evacuate the treatment zone 36.

The treater 10 described herein effects plasma treatment by ionization of the appropriate working media injected into the treatment zone 36 from the working media system 18. Plasma treatment provides high surface energies at the surface being treated, thus raising its mean surface energy and effecting a more homogeneous surface finish as compared to corona treatment. Moreover, a high frequency power supply, such as a high voltage AC power supply operable up to 300 kHz, may be used to effect an even more homogenous surface than lower frequency plasma treatment. The treater 10 can be operated at lower frequencies as well and will provide at least corona level treatment with the enhanced uniformity of plasma treatment.

Helium has been determined to be a suitable gas for effect plasma discharge, and a helium content as low as 80 percent helium can be sufficient for plasma to form. However, the specific gas or gas mixture used as the working media can be selected by on the application, such as the material composition of the article being treated. U.S. Pat. No. 6,429,595, at col. 5, line 13 to col. 6, line 23, the disclosure of which is hereby incorporated by reference, provides a discussion of suitable gas chemistry and operational parameters of the type suitable for use with the present invention.

The working media system 18 includes one or more supply tanks (not shown), for example each containing an inert or reactive gas, and one or more supply lines 60 for injecting the working media into the treatment zone 36. With reference to FIGS. 2, 4 and 6, the electrode mount 40 includes an axial opening in the bracket 42 where a nozzle 62 is disposed which is coupled to the supply line(s) 60. The nozzle 62 can be one or more discrete openings for injecting working media into the treatment zone 36 at one or more discrete locations. However, in the treater 10 described herein the nozzle 62 is a diffuser nozzle, having an integral diffuser as part of the nozzle or a separate diffuser component coupled with the nozzle, such that the working media is injected into the treatment zone 36 and dispersed uniformly along the treatment axis 30. The diffuser nozzle 62 can be made of a heat resistant, porous material, for example, a porous ceramic having an average porosity measurable on the micron scale. The diffuser nozzle 62 is vertically aligned with the treatment axis 30 at the back side of the electrodes 32 and 34.

To contain the working media within the treatment zone an axial barrier member 66 (see FIG. 2) can be mounted at the front side of the electrodes 32 and 34 to form a narrow tunnel bounding the treatment zone 36 where the article is treated. The barrier member 66 can be permanently mounted to the horizontal work surface of the cabinet work space, however, in the treater 10 described herein the barrier member is movable, and if desired even removable. For example, the barrier member 66 could be allowed to be simply lifted out from the front opening or slid horizontally out of end of the cabinet 12, or it could also be pivotal mounted to swing up or down with respect to the treatment axis 30. Any such mounting configuration would allow for the articles to be fed into the treater 10 without the need to be threaded in from one end, through a narrow tunnel and out the other end. And, the barrier member 66 can be made of a heat resistant, non-corrosive and non-conducting material, such as a suitable tempered glass ceramic, for example NeoCeram® or PyroCeram®, and can be translucent or transparent to allow for visual inspection of the discharge.

By preventing the working media from escaping at the front side, the barrier member 66 aids in maintaining the integrity of the working media and the characteristics of the discharge. It also permits high operating frequencies to be used at atmospheric pressure without the risk of ionizing the ambient air rather than the intended working media, which could effect corona treatment, rather than the higher quality plasma treatment. Furthermore, the barrier member 66 helps ensure that the surface of the article is treated homogeneously about its entire cross-sectional periphery.

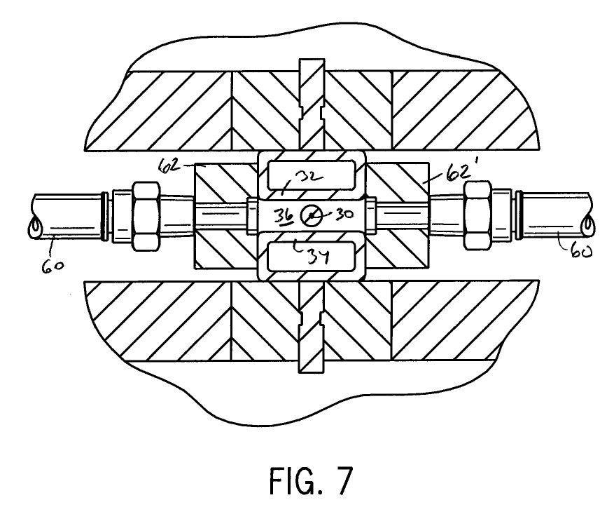

An alternative to the barrier member 66 is shown in FIG. 7, which has a second nozzle 62′ located at the front side of the electrodes 32 and 34 so that working media is injected into the treatment zone 30 from the two opposing transverse sides of the electrodes 32 and 34. Like nozzle 62, nozzle 62′ can be, or can include, a diffuser so that working media is dispersed throughout the length of the electrodes 32 and 34. Diffuser nozzle 62′ could have a porosity similar to the diffuser nozzle 62.

The electrodes 32 and 34 have a hollow interior such that the cooling system 20 can deliver air directly into the electrodes 32 and 34. This has several advantages. First, the cooling air passes by the entire surface area of the interior walls of the electrodes 32 and 34, thereby maximizing heat transfer. Moreover, the compressed air does not draw in contaminants from the work area, which could otherwise be carbonized on the electrodes 32 and 34 and cause arcing during operation. Furthermore, the cooling air does not evacuate or otherwise disrupt the working media in the treatment zone 36, which would adversely affect the quality of the treatment.

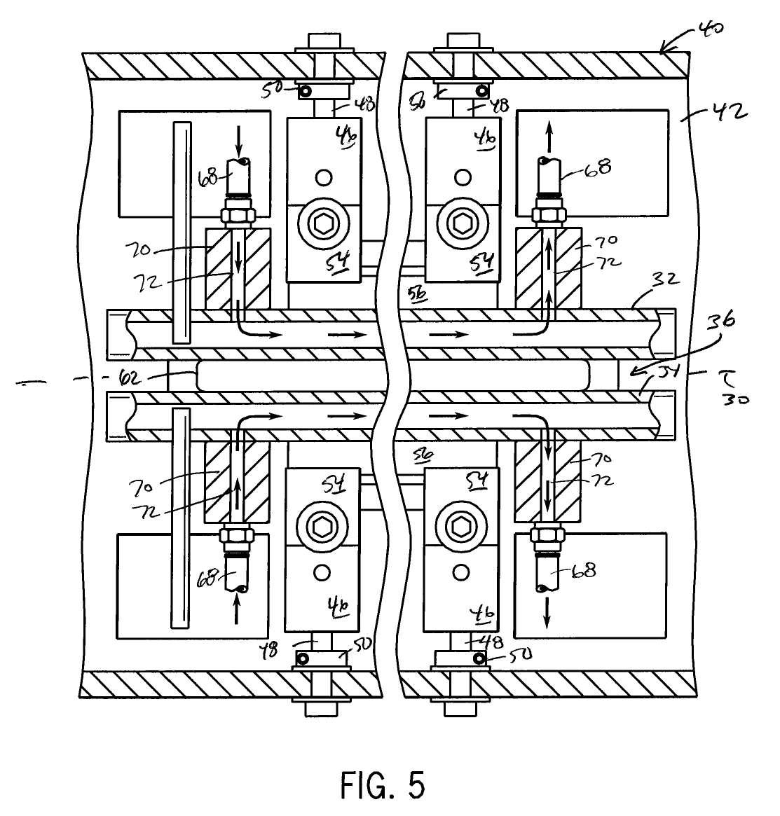

Generally, the cooling air system 20 includes a source of compressed air (not shown) and lines 68 for delivering the cooling air to the electrodes 32 and 34. The cooling air lines 68 can be any suitable solid or flexible conduit for carrying air, such as polyethylene tubing. Referring to FIG. 5, the cooling air lines 68 are connected to the electrodes 32 and 34 via mounts 70, which are mounted to the electrodes 32 and 34 and have internal bores 72 (one shown in FIG. 5) in communication with the hollow interior of the electrodes 32 and 34. Each end of the electrodes 32 and 34 are closed off by a non-conductive end cap (not shown) so that the cooling air flow does not escape from the electrodes 32 and 34. Two fittings 74 are coupled to the bores for coupling to the associated air line 68. The cooling air lines 68 are suitably coupled to the compressed air source such as a dedicated compressor or tap from a facility compressed air system. The air source pumps a suitable volume and flow rate of air, for example approximately 2 CFM, through the air lines 68 and to the interior of the electrodes 32 and 34. In the illustrated embodiment, as noted by the arrows in FIG. 5, the compressed air passes from the inlet fittings at one end of each of the electrodes 32 and 34 though the length of the electrodes 32 and 34 and exits the outlet fittings. The compressed air is relatively cool compared to the high temperatures of the electrodes 32 and 34, which can operate at 100 degrees Celsius or more, such that heat is carried away from the electrodes 32 and 34.

Although not shown, the interior of the electrodes 32 and 34 could be partitioned to define two or more air flow passages, in which case the cooling air system 20 could be configured to flow cooling air in opposite directions through the electrodes 32 and 34. This can serve to provide more uniform cooling along the length of the electrodes 32 and 24 by introduced cooling air from opposite ends. Moreover, various flow path configurations through the electrodes 32 and 34 could be provided.

Moreover, as a further alternative construction of the treater 10, one or both of the electrodes 32 and 34 could be porous, such as a porous metal, having porosity similar to the diffuser nozzle(s) mentioned above. In this case, the working media could be directed from the working media system 18 directing into and through the porous electrode(s) without the need for a separate nozzle and diffuser.

It can be appreciated that many variations are possible from the preferred embodiment described above without departing from the spirit of the invention. Reference should therefore be made to the claims for interpreting the entire scope of the invention.

We claim:

1. A surface treater system for treating the surface of an elongated article, the treater comprising:
a guide for supporting the elongated article along a treatment axis;
a first elongated electrode extending primarily essentially parallel to the treatment axis and spaced from the treatment axis;
a second elongated electrode extending primarily essentially parallel to and spaced from the treatment axis and spaced from the first electrode to define a treatment zone extending along the treatment axis between the first and second electrodes;
an elongated nozzle extending primarily essentially parallel to the treatment axis proximate the first and second electrodes for introducing a working media into the treatment zone along the treatment axis; and
a high voltage power supply operatively connected to the first and second electrodes to ionize the working media in the treatment zone along the treatment axis and thereby increase the surface tension at the surface of the elongated article.

2. The treater of claim 1, wherein the first electrode is disposed on an opposite side of the treatment axis than the second electrode.

3. The treater of claim 1, wherein the first and second electrodes are active electrodes connected to high voltage, the second electrode being at a polarity 180 degrees out of phase with that of the first electrode.

4. The treater of claim 1, wherein the first electrode is an active electrode coupled to high voltage and the second electrode is a ground electrode coupled to ground.

5. The treater of claim 1, wherein one of the first and second electrodes is made of a porous member which forms the nozzle.

6. The treater of claim 1, wherein the nozzle is disposed at a first side of the first and second electrodes transverse to the treatment axis.

7. The treater of claim 6, further including a barrier member disposed to a second side of the first and second electrodes opposite the treatment axis from the nozzle, the barrier member mounted to contain working media within the treatment zone at the second side.

8. The treater of claim 7, wherein the barrier member is movable.

9. The treater of claim 6, further including a second nozzle disposed at a second side of the first and second electrodes opposite the treatment axis from the nozzle and extending in the axial direction so as to introduce working media into the treatment zone from the second side along the treatment axis.

10. The treater of claim 9, wherein the second nozzle is a porous member having openings therein throughout its length for dispersing the working media into the treatment zone along the treatment axis.

11. The treater of claim 1, wherein the first and second electrodes each have a tubular body with an inlet port and an outlet port in communication with an inner cavity through which cooling air is passed.

12. The treater of claim 1, wherein at least one of the first and second electrodes is adjustably mounted so as to vary the size of the treatment zone.

13. The treater of claim 12, further including a support bracket, clamps and mounting blocks connected to the first and second electrodes, wherein the clamps removably and adjustably couple the mounting blocks to the mounting bracket.

14. The treater of claim 1, further including a cabinet creating a treatment chamber open at opposite ends of the cabinet in which the electrode assembly is disposed, the cabinet mounting a guide at each open end for guiding the elongated article through the treatment chamber along the treatment axis.

15. A plasma treater for treating an elongated article, the treater comprising:
a cabinet creating a treatment chamber open at opposite ends of the cabinet;
a guide mounted with respect to the cabinet at each open end of the cabinet for guiding the elongated article and establishing a treatment axis therebetween passing through the treatment chamber of the cabinet along which the elongated article is disposed;
an electrode assembly mounted within the treatment chamber of the cabinet, the electrode assembly having an active electrode coupled to high voltage and a ground electrode coupled to ground each disposed essentially parallel to the treatment axis, the active electrode being spaced from the ground electrode to define a treatment zone along the treatment axis; and
an elongated gas nozzle extending essentially parallel to the treatment axis adjacent to the active and ground electrodes and coupled to a gas line for introducing a gas into the treatment zone and dispersing it along the treatment axis such that when energized the electrode assembly causes the gas to ionize and form plasma in the treatment zone along the treatment axis.

16. The treater of claim 15, wherein the active electrode is disposed on an opposite side of the treatment axis than the ground electrode, the active electrode and the ground electrode being essentially equidistant from the treatment axis.

17. The treater of claim 15, wherein active electrode is a porous member which forms the gas nozzle.

18. The treater of claim 15, wherein the gas nozzle is disposed at a first side of the electrodes transverse to the treatment axis and further including a barrier member disposed to a second side of the electrodes opposite the treatment axis from the gas nozzle such that the barrier member contains gas within the treatment zone at the second side.

19. The treater of claim 17, further including a second gas nozzle disposed at a second side of the electrodes opposite the treatment axis from the gas nozzle and extending in the axial direction so as to introduce gas into the treatment zone from the second side along the treatment axis.

20. The treater of claim 19, wherein the second gas nozzle is a porous member having openings therein throughout its length for dispersing the gas into the treatment zone along the treatment axis.

21. The treater of claim 15, wherein the electrodes each have a tubular body with an inlet port and an outlet port in communication with an inner cavity through which cooling air is passed.

22. The treater of claim 15, wherein at least one of the electrodes is adjustably mounted so as to vary the size of the treatment zone.

23. The treater of claim 22, further including a support bracket, clamps and mounting blocks connected to the electrodes, wherein the clamps removably and adjustably couple the mounting blocks to the mounting bracket.

24. The treater of claim 15, wherein the guides are rotatably mounted with respect to the cabinet and provide grooves in which the elongated article is received such that the elongated article can travel through the treatment chamber along the treatment axis.

25. A plasma treater for treating an elongated article, the treater comprising:
a cabinet creating a treatment chamber open at opposite ends of the cabinet;
a guide mounted with respect to the cabinet at each open end of the cabinet for guiding the elongated article and establishing a treatment axis therebetween passing through the treatment chamber of the cabinet along which the elongated article is disposed;
an electrode assembly mounted within the treatment chamber of the cabinet, the electrode assembly having an active electrode coupled to high voltage and a ground electrode each disposed essentially in parallel with respect to a treatment axis, the active electrode being spaced from the ground electrode to define a treatment zone along the treatment axis;
an elongated gas nozzle extending essentially parallel to the treatment axis adjacent to the active and ground electrodes along a first transverse side of the electrodes and coupled to a gas line for introducing a gas into the treatment zone and along the treatment axis such that when energized the electrode assembly causes the gas to ionize and form plasma in the treatment zone along the treatment axis; and
an elongated member extending in the axial direction and disposed to a second side of the electrodes opposite the treatment axis from the gas nozzle.

26. The treater of claim 25, wherein the elongated member is a second gas nozzle for introducing gas into the treatment zone from the second side.

27. The treater of claim 25, wherein the elongated member is a barrier member for containing working media within the treatment zone at the second side.

28. A process for charging the surface of elongated articles, the process comprising:
supporting an elongated article along a treatment axis, the elongated article extending primarily in the direction of extension of the treatment axis;
providing an electrode assembly having at least a first electrode coupled to high voltage and a second electrode coupled to ground, the electrode assembly being disposed so that the first and second electrodes extend primarily essentially parallel to the treatment axis and are spaced apart to define an elongated treatment zone along the treatment axis;
providing a working media within the treatment zone;
energizing the electrode assembly to ionize the working media within the treatment zone along the treatment axis; and
increasing the surface tension of the elongated article.

29. The process of claim 28, further including:
supporting the elongated article on movable guides; and
conveying the elongated article along the treatment axis through the treatment zone.
